(19) United States
(12) Patent Application Publication
(10) Pub. No.: US 2012/0181081 A1
(43) Pub. Date: Jul. 19, 2012

(54) TRANSMISSION WIRE CAPABLE OF MOUNTING SPARE TUBE FUSE

(76) Inventor: Chi-Wen Cheng, Dongguan (CN)

(21) Appl. No.: 13/007,972

(22) Filed: Jan. 17, 2011

(51) Int. Cl. H02G 3/00

(52) U.S. Cl. 174/70 R

(57) ABSTRACT

A transmission wire capable of mounting a spare tube fuse includes a wire and a tube fuse casing disposed on the wire. The tube fuse casing has a chamber to accommodate the spare tube fuse. The present invention provides the tube fuse casing disposed on the wire to store a spare tube fuse. The structure of the present invention is simple, and the spare tube fuse doesn't occupy the space of the plug. It is convenient to use the present invention. Compared to the conventional power plug which is direct connected with a spare tube fuse, the present invention simplifies the configuration of the power plug and reduces the difficulty in assembling the power plug. This is beneficial for mass production.

### BACKGROUND OF THE INVENTION

1. Field of the Invention

The present invention relates to a transmission wire, and more particularly to a transmission wire capable of mounting a spare tube fuse.

2. Description of the Prior Art

In order to ensure the safety for using electricity, a tube fuse is provided in a circuit to protect against overload or a short circuit. There are two ways to place the tube fuse. One way is that the tube fuse is placed on a socket and a power switch to protect an electric apparatus. Another way is that a spare tube fuse is provided in the power plug for replacement. When the tube fuse of the wire is damaged, the spar tube fuse can be taken out to repair the electric apparatus without delay. This is convenient in use.

However, the spare tube fuse disposed in the power plug increases the size of the power plug, so the configuration of the power plug is complicated and the difficulty in producing and assembling the power plug is increased. This is not beneficial for mass production. If a data transmission cable is also provided with a spare tube fuse, it is more difficult to mount a spare tube fuse on a data transmission cable because the configuration of a data transmission cable is more complicated than that of a power plug, which is inconvenient in use for an electric apparatus. Accordingly, the inventor of the present invention has devoted himself based on his many years of practical experiences to solve this problem.

### SUMMARY OF THE INVENTION

The primary object of the present invention is to provide a transmission wire capable of mounting a spare tube fuse so as to solve the problem of placing the tube fuse.

In order to achieve the aforesaid object, there is provided a transmission wire capable of mounting a spare tube fuse, which comprises a wire and a tube fuse casing disposed on the wire. The tube fuse casing has a chamber to accommodate the spare tube fuse.

Preferably, the tube fuse casing includes a seat and a cover and the seat has the chamber therein.

Preferably, the seat is detachably or undetachably connected to the wire.

Preferably, the seat is secured to the wire by buckling, injection, screw, fastener or glue.

Preferably, the cover is rotatably connected to the seat through a joint portion. The joint portion, the seat and the cover are integral or detachable.

Preferably, the cover is slidably or rotatably connected to the seat.

Preferably, the cover has an inner side provided with a protrusion to extend into the chamber to position the spare tube fuse in place.

Preferably, the wire is an electrical wire of a power plug.

Preferably, the wire is a data transmission cable.

Compared to the prior art, the present invention has the following advantages:
1. The tube fuse casing is disposed on the wire to store a spare tube fuse. The structure of the present invention is simple, and the spare tube fuse doesn't occupy the space of the plug. It is convenient to use the present invention. Compared to the conventional power plug which is direct connected with a spare tube fuse, the present invention simplifies the configuration of the power plug and reduces the difficulty in assembling the power plug. This is beneficial for mass production.
2. The seat is detachably connected to the wire, which is simple in configuration and can be disposed in any desired position of the wire, so the present invention is user-friendly.
3. The wire of the present invention can be an electric wire of a power plug or a data transmission cable, so the present invention can be used widely and provides a safe protection to the electric apparatus.

### BRIEF DESCRIPTION OF THE DRAWINGS

FIG. 1 is a perspective view according to a first embodiment of the present invention;

FIG. 2 is a perspective view to show the seat and the cover in an open status according to the first embodiment of the present invention;

FIG. 3 is an exploded view according to the first embodiment of the present invention; and

FIG. 4 is an exploded view according to a second embodiment of the present invention.

### DETAILED DESCRIPTION OF THE PREFERRED EMBODIMENTS

Embodiments of the present invention will now be described, by way of example only, with reference to the accompanying drawings.

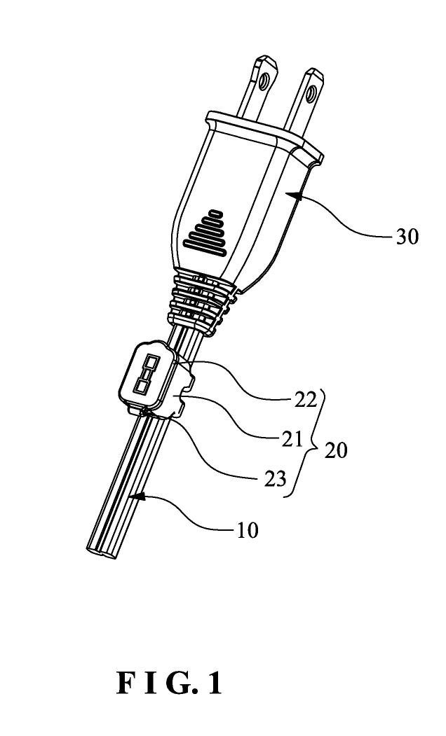

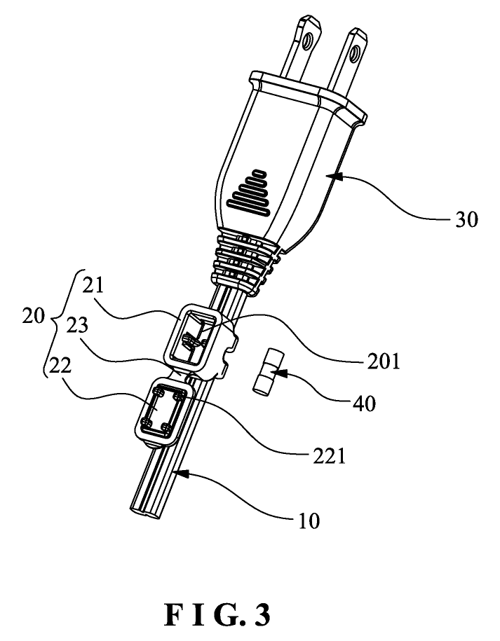

As shown in FIG. 1 to FIG. 3, a preferred embodiment of the present invention comprises a wire 10 and a tube fuse casing 20.

As shown in FIG. 1, the wire 10 is an electrical wire of a power plug. One end of the electrical wire is connected with a power plug 30.

The tube fuse casing 20 is disposed on the wire 10. The tube fuse casing 20 includes a seat 21 and a cover 22. The seat 21 has a chamber 201 to receive a spare tube fuse 40. The seat 21 can be detachably or undetachably connected to the wire 10. The seat 21 can be secured to the wire 10 by buckling, injection, screw, fastener or glue. In this embodiment, the seat 21 is integrally formed with the wire 10 by injection, but not limited. The cover 22 is slidably or rotatably connected to the seat 21. In this embodiment, the cover 22 is rotatably connected to the seat 21 through a joint portion 23, but no limited. The joint portion 23, the seat 21 and the cover 22 can be integral or detachable, but not limited. In this embodiment, they are integral and the cover 22 is buckled to the seat 21. The cover 22 has an inner side provided with a protrusion 221. When the cover 22 is buckled to the seat 21, the protrusion 221 extends into the chamber 201 to position the spare tube fuse 40 in place.

To assemble the present invention, the tube fuse casing 20 is disposed on the wire 10. The seat 21 is secured to the wire 10 by buckling, injection, screw, fastener or glue, as shown in FIG. 1.

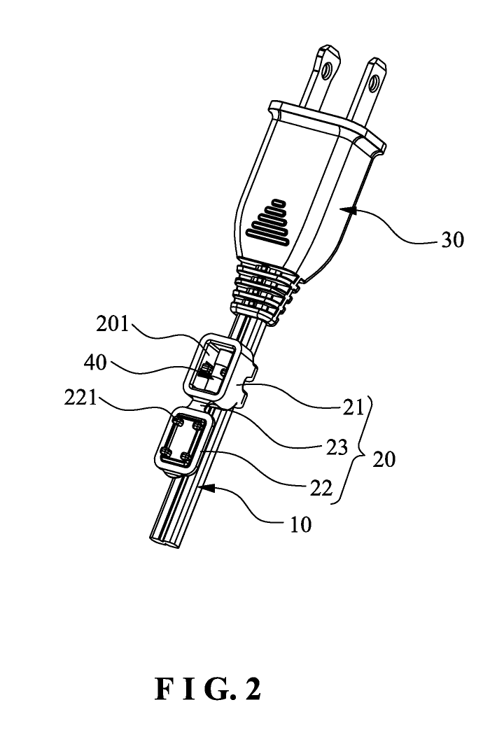

When in use, the spare tube fuse 40 is placed in the chamber 201, as shown in FIG. 2. After that, the cover 22 is rotatably secured to the seat 21 through the joint portion 23, as shown in FIG. 1, such that the tube fuse 40 is secured in the chamber 201 of the tube fuse casing 20. In case the electric current of the wire 10 is abnormal to burn the tube fuse of an electric apparatus, the user can open the cover 22 to take out the spare tube fuse 40 for replacement, so that the electric apparatus can be repaired without delay.

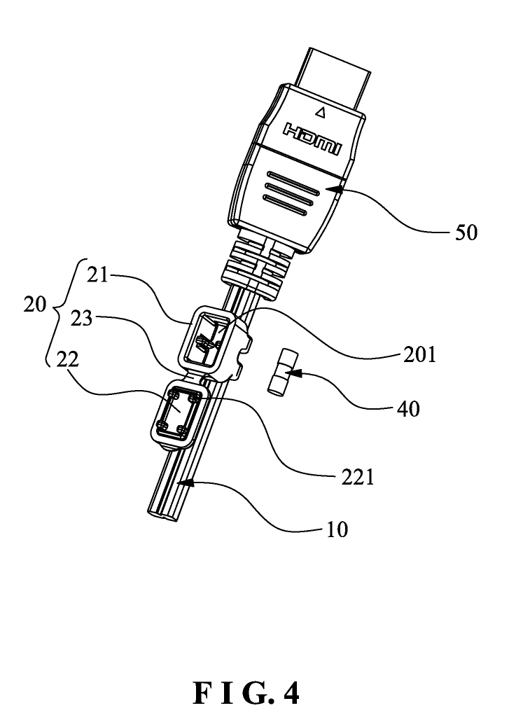

FIG. 4 shows a second embodiment of the present invention, which is substantially similar to the first embodiment with the exceptions described hereinafter. In this embodiment, the wire 10 is a data transmission cable which has one end connected with a HDMI plug 50. The data transmission cable can be connected with a USB plug, but not limited. The assembly and use of the second embodiment are identical to the first embodiment and won't be described hereinafter.

The present invention provides the tube fuse casing disposed on the wire to store a spare tube fuse. The structure of the present invention is simple, and the spare tube fuse doesn't occupy the space of the plug. It is convenient to use the present invention. Compared to the conventional power plug which is direct connected with a spare tube fuse, the present invention simplifies the configuration of the power plug and reduces the difficulty in assembling the power plug. This is beneficial for mass production. Furthermore, the seat is detachably connected to the wire, which is simple in configuration and can be disposed in any desired position of the wire, so the present invention is user-friendly. Besides, the wire of the present invention can be an electric wire of a power plug or a data transmission cable, so the present invention can be used widely and provides a safe protection to the electric apparatus.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A transmission wire capable of mounting a spare tube fuse, comprising a wire and a tube fuse casing disposed on the wire, the tube fuse casing having a chamber to accommodate the spare tube fuse.

2. The transmission wire capable of mounting a spare tube fuse as claimed in claim 1, wherein the tube fuse casing includes a seat and a cover and the seat has the chamber therein.

3. The transmission wire capable of mounting a spare tube fuse as claimed in claim 2, wherein the seat is detachably or undetachably connected to the wire.

4. The transmission wire capable of mounting a spare tube fuse as claimed in claim 2, wherein the seat is secured to the wire by buckling, injection, screw, fastener or glue.

5. The transmission wire capable of mounting a spare tube fuse as claimed in claim 2, wherein the cover is rotatably connected to the seat through a joint portion, and the joint portion, the seat and the cover are integral or detachable.

6. The transmission wire capable of mounting a spare tube fuse as claimed in claim 2, wherein the cover is slidably or rotatably connected to the seat.

7. The transmission wire capable of mounting a spare tube fuse as claimed in claim 2, wherein the cover has an inner side provided with a protrusion to extend into the chamber to position the spare tube fuse in place.

8. The transmission wire capable of mounting a spare tube fuse as claimed in claim 1, wherein the wire is an electrical wire of a power plug.

9. The transmission wire capable of mounting a spare tube fuse as claimed in claim 1, wherein the wire is a data transmission cable.
